(19) United States
(12) Patent Application Publication
(10) Pub. No.: US 2008/0017720 A1
(43) Pub. Date: Jan. 24, 2008

(54) MULTI-USE PAYMENT CARD AND METHODS OF USING SAME

(76) Inventor: Arthur D. Kranzley, Pound Ridge, NY (US)

Correspondence Address: BUCKLEY, MASCHOFF & TALWALKAR LLC, 50 LOCUST AVENUE, NEW CANAAN, CT, 06840, US

(21) Appl. No.: 11/773,594

(22) Filed: Jul. 5, 2007

Related U.S. Application Data
(60) Provisional application No. 60/818,894, filed on Jul. 6, 2006.

(51) Int. Cl. G06K 19/06

(52) U.S. Cl. 235/493

(57) ABSTRACT

A payment card includes a card body and a magnetic stripe on the card body. The magnetic stripe stores a first account number. The payment card also includes an antenna disposed on the card body and a storage device mounted in the card body. The storage device is coupled to the antenna and stores data representative of a second account number that is different from the first account number.

### CROSS-REFERENCE TO RELATED APPLICATION

This application claims the benefit of U.S. Provisional Patent Application Ser. No. 60/818,894, filed Jul. 6, 2006, which is incorporated herein in its entirety.

### BACKGROUND

It has previously been proposed that one payment card, in the general form of a conventional credit card or debit card, be used to access more than one account. For example, U.S. Pat. No. 5,276,311, issued to Hennige, discloses a payment card in which a number of different payment card account numbers are stored in a “computer chip”.

As another example, U.S. Pat. No. 6,631,849, issued to Blossom, discloses a payment card having plural magnetic stripes, each of which is used to access a different respective account. In another embodiment disclosed in the '849 patent, a payment card has a programmable magnetic stripe. In this embodiment, the card also has buttons that may be pressed by the user to select the account number to be presented with the programmable magnetic stripe.

However, these proposed multiple-account payment cards tend to be quite complex, requiring features that may significantly increase the manufacturing cost for the card. In addition, or alternatively, the manner in which a user selects an account to be accessed with the card for a particular transaction may be inconvenient, or may even not be clearly addressed.

It would be desirable to provide a single payment card that is relatively simple in construction, while being usable to access more than one account in a manner that is easy and convenient for the cardholders

### BRIEF DESCRIPTION OF THE DRAWINGS

FIG. 1 is a schematic plan view showing the reverse side of a payment card provided according to some embodiments.

FIG. 2 is a flow chart that illustrates a process for using the payment card of FIG. 1.

FIG. 3 is a block diagram representation that illustrates use of the payment card of FIG. 1 according to one aspect of the process of FIG. 2.

FIG. 4 is a block diagram representation that illustrates use of the payment card of FIG. 1 according to another aspect of the process of FIG. 2.

### DETAILED DESCRIPTION

In general, and for the purposes of introducing concepts of embodiments of the present invention, a payment card has a magnetic stripe that has encoded thereon a first account number that may be used to access a first financial account. The payment card also has an antenna to allow the payment card to communicate with a point-of-sale terminal via proximity coupling. A data storage device is included in the payment card and is coupled to the antenna. The data storage device stores a second account number that is different from the first account number. The second account number may be used to access a second financial account that is different from the first financial account.

When the payment card is presented to a point-of-sale terminal by having the magnetic stripe on the card read, the transaction in question is charged to the financial account identified by the account number encoded on the magnetic stripe. When the payment card is presented to a point-of-sale terminal by proximity coupling, a wireless signal from the payment card to the point-of-sale terminal communicates the account number stored in the data storage device, and the transaction in question is charged to the financial account identified by the account number stored in the data storage device.

In this way, the cardholder can select between two accounts controlled by the payment card by simply choosing whether to present the payment card by magnetic stripe reading or by proximity coupling.

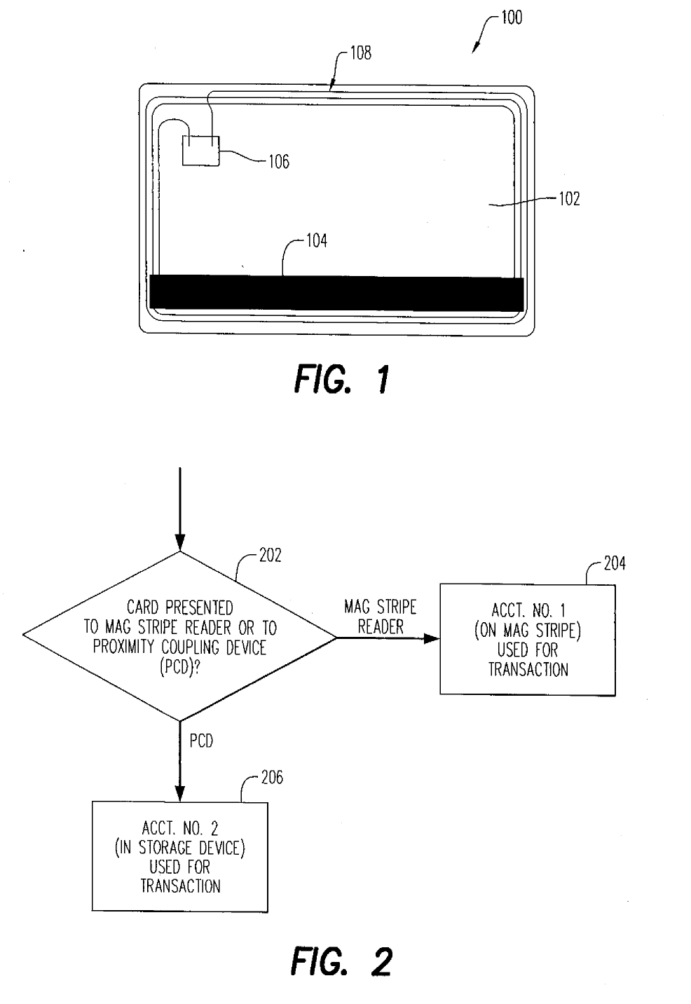

FIG. 1 is a schematic plan view showing the reverse side of a payment card 100 provided according to some embodiments. The drawing is schematic at least in the sense that the drawing shows certain components of the payment card which may, in practical embodiments of the card, be internal to the card and hence not visible. In addition, certain conventional payment card features, which may be present in the payment card 100, are not shown in the drawing.

In outward appearance, the payment card 100 may be indistinguishable from conventional credit or debit cards of the type in widespread use today. The payment card 100 may include a card body 102 which may be formed of plastic and may have the same shape and size as a standard credit or debit card.

The payment card 100 may also include a magnetic stripe 104 carried on the card body 102. The magnetic stripe 104 may be configured and located on the card body 102 in a conventional manner. Further, conventional information, including an account number, cardholder name, etc., may be recorded on the magnetic stripe in a conventional manner, such as that which conforms to published standards for magnetic stripes on credit or debit cards.

In addition, the payment card may include a data storage device 106 and an antenna 108 to which the storage device 106 is coupled. Both the data storage device 106 and the antenna 108 may in practice be embedded in the card body 102, and hence may not be visible. The antenna 108 may take the form of several metal wire turns around the periphery of the card body 102, as shown in FIG. 1. The storage device 106 may be located in a corner 110 of the card body 102, as shown. In other embodiments, the antenna may have a different configuration from that shown, and/or the storage device may be in a different location from that shown. Moreover, the manner in which the storage device is coupled to the antenna may be different from that shown. For example, the connection between the storage device and the antenna may be single-ended rather than double ended.

In accordance with known practices, the data storage device 106 may store an account number to be wirelessly transmitted from the payment card 100 (via the antenna 108) when the payment card is presented for proximity coupling to a point-of-sale terminal. However, the account number stored in the data storage device 106 may be different from the account number recorded on the magnetic stripe 104, and hence may identify a financial account that is different from the financial account identified by the account number recorded on the magnetic stripe 104.

In some embodiments, the data storage device 106 and the antenna 108 may operate for purposes of proximity coupling to point-of-sale terminals in accordance with the “PayPass” standard promulgated by MasterCard International Incorporated, the assignee hereof. That is, the data storage device 106 may be powered by, and transmit one or more wireless signals in response to, an interrogation signal received from a proximity coupling device (PCD—not shown in FIG. 1) which is part of a point-of-sale terminal, and which the payment card 100 is presented to in order to pay for a transaction. At least one wireless signal from the payment card 100 to the point-of-sale terminal includes data that represents the account number stored in the data storage device 106. A suitable encryption technique may be employed to guard the account number from interception.

In some embodiments, the account number stored in the data storage device 106 is not recorded on the magnetic stripe 104, and the account number recorded on the magnetic stripe 104 is not stored in the data storage device 106.

The payment card 100 may have other, conventional, features not indicated by the drawing. For example, the payment card 100 may have embossed numbers and/or letters thereon to indicate the name of the cardholder and one or both of the account numbers for the accounts controlled by the payment card. In addition, the face of the card may carry one or more logos and/or brands, including, for example, the brand/logo of a national payment card association such as MasterCard International Incorporated. The brand/logo of the issuer may also be present, as well as, for example, a specific card product brand.

Other conventional features that may be present on the payment card are an adhesive paper strip to receive the signature of the cardholder, and a security code or the like printed on the adhesive strip.

FIG. 2 is a flow chart that illustrates a process for using the payment card 100.

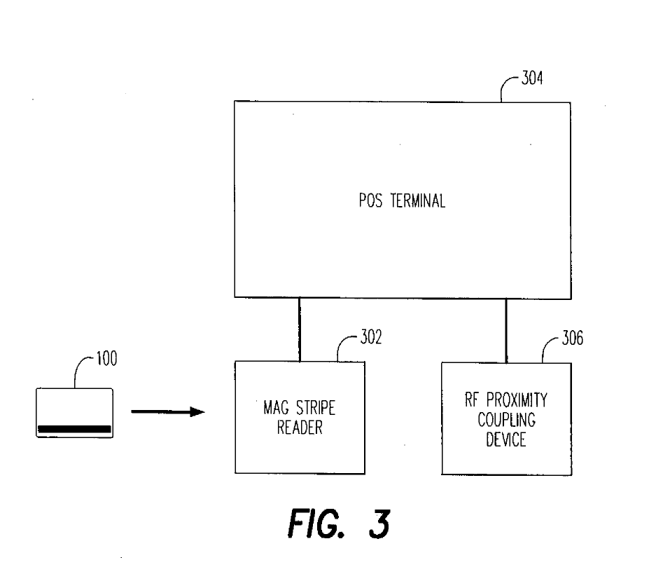

For purposes of the process of FIG. 2, it is assumed that the cardholder is present at a point-of-sale terminal in a retail store and wishes to use one of the accounts controlled by the payment card 100 to pay for a transaction at the point-of-sale terminal. At 202, the cardholder decides whether to use the account represented by the account number recorded on the magnetic stripe 104 or the account represented by the account number stored in the data storage device 106. Let it be assumed first that the cardholder decides to use the account represented by the account number recorded on the magnetic stripe 104. Then, as illustrated in FIG. 3, the cardholder swipes (or allows the sales clerk to swipe) the magnetic stripe 104 through a magnetic stripe reader 302 that is coupled to the point-of-sale terminal 304. (The POS terminal 304 may be coupled in a conventional manner to a payment authorization network—not shown—or the like.) The magnetic stripe reader 302 reads the account number recorded on the magnetic stripe 104, and the point-of-sale terminal transmits the account number via the “rails” for authorization, etc., in a conventional manner. As a result, the account represented by the account number recorded on the magnetic stripe 104 is used to pay for the current transaction, as indicated at 204 in FIG. 2. In this case, it may be said that the cardholder has selected the account represented by the account number recorded on the magnetic stripe by allowing the magnetic stripe to be read by the magnetic stripe reader. It may also be said that the cardholder has selected between the two accounts accessible with the payment card by allowing the magnetic stripe on the card to be read.

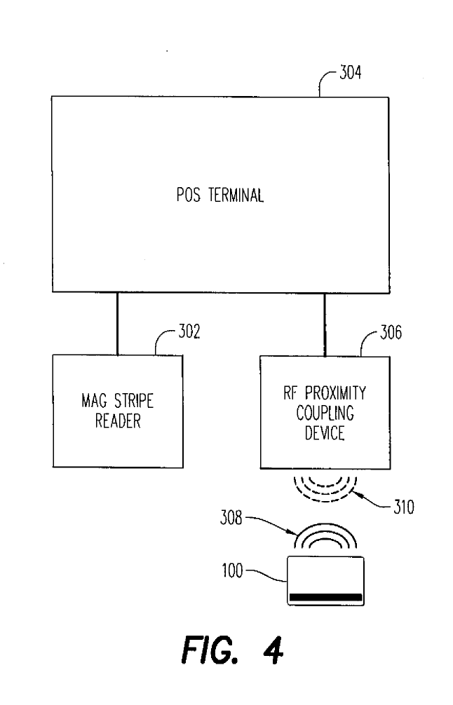

Let it next be assumed that the cardholder decides instead to use the account represented by the account number stored in the data storage device 106. In this case, as illustrated in FIG. 4, the cardholder presents the payment card 100 to a proximity coupling device 306 so that data representing the account number stored in the data storage device 106 is transmitted to the PCD 306 of the POS terminal 304 in a wireless signal 308. (The wireless signal 308 may be transmitted by the payment card 100 in response to an interrogation signal 310—shown in phantom—from the PCD 306.) In a conventional manner, the account number transmitted wirelessly from the payment card 100 may be transmitted/processed by the POS terminal 304 so that the account represented by the account number stored in the storage device 106 is used to pay for the current transaction, as indicated at 206 in FIG. 2. It may be said that the cardholder has selected the account represented by the account number stored in the storage device 106 by allowing the payment card to transmit to the POS terminal a wireless signal including that account number. It may also be said that the cardholder has selected between the two accounts controlled by the payment card by allowing the payment card to transmit the wireless signal.

The cardholder may decide, on different occasions, to use different accounts to pay for different transactions. Thus for one transaction on one occasion, the cardholder may select the account represented by the account number recorded on the magnetic stripe 104. For another transaction on another occasion, the cardholder may select the account represented by the account number stored in the data storage device 106.

It is very easy and convenient for the cardholder to select between the two accounts accessible by the payment card. To select one account, the cardholder merely causes the magnetic stripe to be read by a magnetic stripe reader; to select the other account, the cardholder simply presents the payment card to a PCD.

The two accounts for which the account numbers are respectively recorded on the magnetic stripe and stored in the data storage device may be of the same type or of different types. The accounts may be of any type typically accessed by use of a payment card. For example, both accounts may be credit card accounts or debit card accounts, or one may be a credit card account and the other a debit card account. One of the accounts may be issued under the auspices of a national payment card association such as MasterCard International Incorporated, while the other may be a charge account that is proprietary to a particular retailer (e.g., a Sears credit card). One account may be the cardholder's individual credit or debit card account, while the other account may be a credit or debit card account of a business entity with which the cardholder is associated. At least one of the accounts may be a so-called “loyalty account” which is used not to pay for transactions, but rather to track purchases at a particular retailer. Either or both of the accounts accessible with the payment card may be a revolving credit account or an installment credit account.

In some embodiments, the data storage device may operate as a monetary value store in addition to or instead of operating as an account number store. Accordingly, the payment card 100 may function as a stored value card in addition to being a credit or debit card or the like. In such embodiments, presenting the card for proximity coupling at the point of sale may result in the current payment being made from monetary value stored in the data storage device. The payment from stored value, and deduction of the paid amount from the amount stored in the data storage device, may be implemented through an exchange of wireless signals between the PCD and the payment card.

In some embodiments, the data storage device may store other or different kinds of data besides an account number and/or data indicative of stored value.

For purposes of the appended claims, an antenna may be considered “disposed on” a card body if at least partially encapsulated in or molded into the card body and/or at least partially supported by the card body.

As used herein and in the appended claims, the term “account number” refers to any string of characters and/or numerals used to identify an account.

A data storage device is considered “coupled” to an antenna if and only if an electrically conductive signal path is provided between the data storage device and the antenna.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A payment card comprising:
a card body;
a magnetic stripe on the card body, the magnetic stripe storing a first account number;
an antenna disposed on the card body; and
a storage device mounted in the card body, the storage device coupled to the antenna and storing data representative of a second account number different from the first account number.

2. The payment card of claim 1, wherein the antenna is operative to radiate a signal that is indicative of the second account number.

3. The payment card of claim 1, wherein the second account number is not stored on any magnetic stripe on the card body.

4. The payment card of claim 1, wherein the first account number is not stored in any storage device coupled to the antenna.

5. A method of using a payment card, the method comprising:
selecting, on a first occasion, a first account accessible by the payment card, by allowing a magnetic stripe on the payment card to be read; and
selecting, on a second occasion, a second account accessible by the payment card, by allowing the payment card to transmit a wireless signal via an antenna, the second account different from the first account.

6. The method of claim 5, wherein the wireless signal is transmitted in response to an interrogation signal received by the antenna.

7. The method of claim 6, wherein the allowing the payment card to transmit the wireless signal includes placing the payment card in proximity to a device which transmits the interrogation signal.

8. The method of claim 5, wherein both of the accounts are credit card accounts.

9. The method of claim 5, wherein both of the accounts are debit card accounts.

10. The method of claim 5, wherein one of the accounts is a credit card account and another of the accounts is a debit card account.

11. A method of using a payment card, the method comprising:
selecting between a first account accessible with the payment card and a second account accessible with the payment card by allowing a magnetic stripe on the payment card to be read; and
selecting between the first account and the second account by allowing the payment card to transmit a wireless signal via an antenna.

12. The method of claim 11, wherein the first account is selected when the magnetic stripe is read and the second account is selected when the wireless signal is transmitted.

13. The method of claim 11, wherein both of the accounts are credit card accounts.

14. The method of claim 13, wherein the first account is branded by a national payment card association and the second account is proprietary to a particular retailer.

15. The method of claim 13, wherein the first account is held by an individual and the second account is held by a business entity.

16. A method of using a payment card, the method comprising:
providing a card that carries a magnetic stripe on which an account number is encoded, the card also having an antenna and a storage device coupled to the antenna, the storage device operative as a value store;
presenting the card on a first occasion to charge a first transaction to an account represented by the account number, by allowing the magnetic stripe to be read; and
presenting the card on a second occasion to pay for a second transaction with monetary value stored in said storage device, by allowing the card to exchange wireless signals with a payment terminal via the antenna.

17. The method of claim 16, wherein the account represented by the account number is a credit card account.

18. The method of claim 17, wherein the credit card account is branded by a national payment card association.

19. The method of claim 17, wherein the credit card account is proprietary to a particular retailer.

20. The method of claim 16, wherein the account represented by the account number is a debit card account.
